(19) United States
(12) Patent Application Publication
(10) Pub. No.: US 2026/0164100 A1
(43) Pub. Date: Jun. 11, 2026

(54) AUTHORING METHODS FOR CREATING INTERACTIVE MECHANICAL ASSEMBLY ANIMATIONS IN VIRTUAL ENVIRONMENTS

(71) Applicant: Purdue Research Foundation, West Lafayette, IN (US)

(72) Inventors: Karthik Ramani, West Lafayette, IN (US); Asim Unmesh, Indianapolis, IN (US); Mayank Harendra Patel, West Lafayette, IN (US)

(21) Appl. No.: 19/412,334

(22) Filed: Dec. 8, 2025

Related U.S. Application Data
(60) Provisional application No. 63/729,503, filed on Dec. 9, 2024.

(51) Int. Cl. H04N 21/8545; G06T 13/20; H04N 21/81; H04N 21/84

(52) U.S. Cl. CPC H04N 21/8545; G06T 13/20; H04N 21/816; H04N 21/84

(57) ABSTRACT

A method and system are for generating animated instructional content depicting assembly instructions of an assembly. The assembly includes a plurality of objects. The method includes disassembling a virtual model of the assembly from an assembled state to a disassembled state using a processor by executing instructions that implement a disassembly algorithm. The disassembly algorithm is configured to output for each object of the plurality of objects (i) a disassembly path included in a plurality of disassembly paths, and (ii) a disassembly step included in a disassembly sequence. The method further includes generating, with the processor, for each object of the plurality of objects an assembly path and an assembly step by reversing the plurality of disassembly paths and the disassembly sequence. Each assembly path is included in a plurality of assembly paths, and each assembly step included in an assembly sequence.

This application claims the benefit of priority of U.S. provisional application Ser. No. 63/729,503, filed on Dec. 9, 2024, the disclosure of which is herein incorporated by reference in its entirety.

### FIELD

The device and method disclosed in this document relates to augmented reality (“AR”) and virtual reality (“VR”) and, more particularly, to the development of an intuitive authoring system that simplifies the creation of AR/VR assembly animations by leveraging interactions categories between assembly components and automating key steps of the animation process.

### BACKGROUND

Unless otherwise indicated herein, the materials described in this background section are not admitted to be the prior art.

Mechanical assembly animations play a critical role in conveying complex technical processes effectively. Traditionally, static images or videos, such as CAD-generated animations, have been the standard mediums for presenting assembly instructions. However, recent advances in AR/VR have introduced the potential for interactive assembly animations, offering several advantages, such as shorter task completion times and fewer errors during assembly tasks. Despite these benefits, current authoring tools lack the specialized features needed to support the creation of intuitive, interactive animations for AR/VR, and existing authoring tools do not provide a structured framework or guiding principles for authoring such content.

For example, as AR/VR interfaces gain popularity, one of the major bottlenecks lies in authoring assembly animations efficiently. Traditional authoring tools for 3D assembly animations offer high expressiveness, but require significant training and expertise, making them less accessible to novices. Various approaches have been developed to simplify the authoring process. For instance, keyframe-based methods, common in computer-aided design (“CAD”) software, allow users to create animations by inserting keyframes along a timeline. While flexible, these methods can be complex and challenging for beginners. To further ease the authoring process, several authoring-by-demonstration systems have emerged. These systems allow users to create AR assembly animations by demonstrating the process in real-time, or generate animations by tracking and recording physical object manipulations. Other tools enable users to author augmented reality instructions without requiring programming skills. Despite their benefits in reducing the need for scripting, each of these approaches often require manual demonstrations or specialized tracking setups, making scalability a challenge. Procedural approaches, which use visual node-based programming, allow users to create animations without writing code. These methods democratize animation authoring for AR/VR, but come with their own limitations, such as the complexity of node graphs, which can overwhelm novice and intermediate users when dealing with large assemblies. Scripting-based approaches offer complete control but require significant time and expertise, limiting their usability for non-expert users.

Based on the above, known authoring tools for generating assembly animations require users to learn a parent software and are often constrained by limited support and capabilities. As a result, there remains a significant need for a more effective animation authoring solution that addresses these challenges in AR/VR-based assembly authoring.

### SUMMARY

According to an exemplary embodiment of the disclosure, a method is for generating animated instructional content depicting assembly instructions of an assembly. The assembly including a plurality of objects. The method includes disassembling a virtual model of the assembly from an assembled state to a disassembled state using a processor by executing instructions that implement a disassembly algorithm. The disassembly algorithm is configured to output for each object of the plurality of objects (i) a disassembly path included in a plurality of disassembly paths, and (ii) a disassembly step included in a disassembly sequence. The method further includes generating, with the processor, for each object of the plurality of objects an assembly path and an assembly step by reversing the plurality of disassembly paths and the disassembly sequence. Each assembly path is included in a plurality of assembly paths, and each assembly step included in an assembly sequence. The method also includes authoring, with the processor, at least one assembly animation showing at least one agent object of the plurality of objects moving from the disassembled state to the assembled state along a corresponding assembly path of the plurality of assembly paths based on (i) an identification of at least one target object of the plurality of objects on which the at least one agent object is to be assembled, and (ii) an identification of at least one corresponding predetermined interaction category of a plurality of predetermined interaction categories. According to the method the at least one assembly animation is included in the animated instructional content. Each predetermined interaction category specifies (i) a spatial transformation of the at least one agent object relative to the at least one target object, and/or (ii) a connection action between the at least one agent object and the at least one target object.

### BRIEF DESCRIPTION OF THE DRAWINGS

The foregoing aspects and other features of the method are explained in the following description, taken in connection with the accompanying drawings.

FIG. 1 is a block diagram show an AR system for authoring animated instructional content including animations in the AR/VR environment;

FIG. 2A shows a portion of a virtual model of an assembly in a partially disassembled state;

FIG. 2B shows an animation control interface used to input data to the AR system for generating animations;

FIG. 2C shows the virtual model of the assembly and shows a cylinder in a disassembled state at the beginning of an animation and the cylinder in the assembled state at the end of the animation;

FIG. 2D shows a liaison graph providing step-by-step demonstration principles and enabling user-guided animation sequences within assembly constraints;

FIG. 2E shows the virtual model both with and without annotations that highlight certain features by the changing the color and/or the opacity of selected objects for animation;

FIG. 2F shows the virtual model with an arrow annotation indicating a movement trajectory of a selected objects for animation;

FIG. 3 is a flowchart showing an exemplary method of operating the AR system of FIG. 1 to generate the animated instructional content;

FIG. 4A shows a virtual model of a toy car in a fully assembled configuration;

FIG. 4B shows a convex hull generated for the objects of the virtual model of FIG. 4A;

FIG. 4C shows an overlay of the toy car of FIG. 4A with the convex hull of FIG. 4B;

FIG. 5A shows an unsolvable case interface that is used to collect information when the disassembly algorithm is unable to automatically generate a disassembly path for a corresponding object of the virtual model of the assembly;

FIG. 5B shows a portion of the virtual model of the assembly with an unsolvable subassembly of objects identified with a circle for emphasis;

FIG. 5C shows that the user has selected certain objects of the subassembly;

FIG. 5D shows that the objects selected in FIG. 5C having been translated along an axis;

FIG. 5E shows that the user has selected a spring of the subassembly;

FIG. 5F shows that the selected spring has been compressed;

FIG. 5G shows that the compressed spring has been translated along an axis;

FIG. 5H shows that the remining objects of the subassembly are translated individually along user defined disassembly paths;

FIG. 6A illustrates a chart showing time required for animation authoring for a baseline system and for the AR system disclosed herein; and

FIG. 6B illustrates several charts showing user response ratings for both the baseline system and AR system disclosed herein.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

### Overview

The method and system described herein overcome challenges in authoring mechanical assembly animations that are AR/VR-compatible. Specifically, the method and system simplify the creation of AR/VR assembly animations by utilizing a hybrid approach for disassembly planning and for assembly planning. The method begins with virtual 3D model of the assembly. During disassembly planning, the method and system utilize a physics-based assembly-by-disassembly algorithm to disassembly the virtual model, a process that includes generating disassembly paths and disassembly step (included in a disassembly sequence) for each object of the assembly included in the virtual model. When the algorithm encounters an unsolvable disassembly case for a particular object, the method and system prompt the author (i.e., a user) to manually adjust the disassembly path and/or an order of the disassembly step for that particular object. Each other object of the virtual model is provided with an automatically generated disassembly path and disassembly step, and the author exerts effort only for the unsolvable cases, complex disassembly steps, or any step of particular interest to the author.

During assembly planning, the method and system leverage several interaction categories that provide the user with an intuitive framework for quickly and easily defining relationships between the objects being assembled. The interaction categories are based on action words that users typically employ when describing assembly animations (e.g., attach, connect, insert), and the interaction categories simplify the animation process for any object, as selected by the author. The assembly planning further enables the author to add annotations to the animations including text labels, audio narration, and directional arrows. Each stage of the authoring process is shown on an easy to understand animation control interface that is visible in the AR/VR environment.

Based on the above, the method and system guides users through a streamlined workflow that integrates foundational principles of effective animation design into the authoring of mechanical assembly animations. The disclosed approach ensures that the assembly animations adhere to pedagogical standards, making them clear and comprehensible. The method and system reduce authoring time while maintaining high instructional quality, resulting in the efficient creation of complex assembly animations for AR/VR applications and environments.

### System Structure

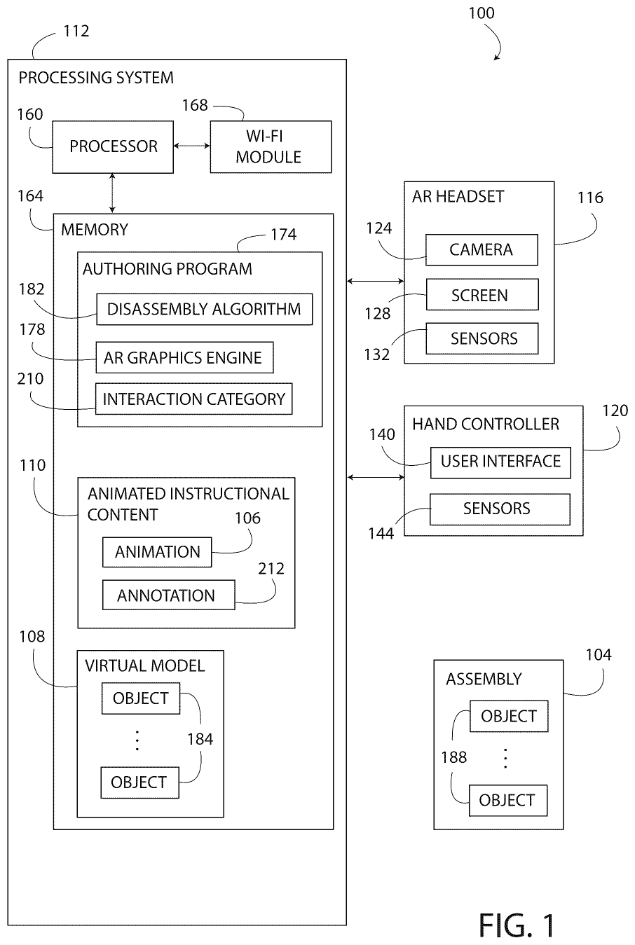

FIG. 1 shows an AR system 100 and an assembly 104. The AR system 100 is for generating interactive mechanical assembly animations 106 of a virtual model 108 of the assembly 104 that can be used to assemble the physical version of the assembly 104, for example, in an AR/VR environment. In one embodiment, the animations 106 are included in animated instructional content 110 depicting assembly instructions for assembling the assembly 104. The illustrated and described components of the AR system 100 are merely exemplary, and the AR system 100 may comprise any alternative configuration. The AR system 100 is also referred to herein as an AR/VR system 100. Moreover, in the illustration of FIG. 1, only a single AR system 100 is illustrated. In practice, however, the multiple AR systems 100 (and corresponding user/operators) may be utilized to assemble the assembly 104.

The AR system 100 includes a processing system 112, an AR headset 116, and a hand controller 120. The AR headset 116 and the hand controller 120 are operably connected to the processing system 112 and are configured to be worn or held by the user, both as the user generates the animated instructional content 110 and as the user (or a different user) assembles the assembly 104 using the generated animated instructional content 110.

The AR headset 116, which is also referred to as an augmented reality head-mounted display (“AR-HMD”) includes at least a camera 124, a display screen 128, and sensors 132. The camera 124 is configured to capture a plurality of images of the environment in real-time as the head-mounted AR headset 116 is moved through the environment by the user. The captured images from the camera 124 each comprise a two-dimensional array of pixels. Each pixel has corresponding photometric information (intensity, color, and/or brightness). In some embodiments, the camera 124 is configured to generate RGB-D images in which each pixel has corresponding photometric information and geometric information (depth and/or distance). In such embodiments, the camera 124 may, for example, take the form of two RGB cameras configured to capture stereoscopic images, from which depth and/or distance information can be derived, or an RGB camera with an associated infrared (“IR”) camera configured to provide depth and/or distance information.

The display screen 128 of the AR headset 116 comprises any of various known types of displays, such as liquid crystal displays (“LCD”) or organic light emitting diode (“OLED”) screens. In at least one embodiment, the display screen 128 is a transparent screen, through which a user can view the outside world (including the assembly 104), on which certain graphical elements are superimposed onto the user's view of the outside world. In the case of a non-transparent display screen 128, the graphical elements may be superimposed on real-time images/video captured by the camera 124.

With reference still to FIG. 1, the sensors 132 of the AR headset 116 are configured to measure one or more accelerations and/or rotational rates of the AR headset 116 which is worn upon the user's head. In one embodiment, the sensors 132 comprises one or more accelerometers configured to measure linear accelerations of the AR headset 116 along one or more axes (e.g., roll, pitch, and yaw axes) and/or one or more gyroscopes configured to measure rotational rates of the AR headset 116 along one or more axes (e.g., roll, pitch, and yaw axes). In some embodiments, the sensors 132 include light detection and ranging (“LIDAR”) sensors or IR cameras. In other embodiments, the sensors 132 include inside-out motion tracking sensors configured to track human body motion of the user within the environment, in particular positions and movements of the head, arms, hands, torso, legs, and feet of the user as well as the positions and movements of the objects 188. The sensors 132 are optional components of the AR headset 116 and only certain embodiments of the AR headset 116 include the sensors 132.

In some embodiments, the AR headset 116 also includes a battery or other power source (not shown) configured to power the various components within the AR headset 116, which may include the processing system 112. For example, the battery of the AR headset 116 is a rechargeable battery configured to be charged when the AR headset 116 is connected to a battery charger configured for use with the AR headset 116.

In other embodiments, the AR headset 116 is provided as any mobile AR device, such as, but not limited to, a smartphone, a tablet computer, a handheld camera, or the like having a display screen and a camera. In a specific example, the AR headset 116 is provided as Microsoft's HoloLens, Oculus Rift, or Oculus Quest or equivalent AR glasses.

With continued reference to FIG. 1, the hand controller 120 comprises a user interface 140 and sensors 144. At least one hand controller 120 is included in the AR system 100. In one embodiment, the AR system 100 includes a left hand controller 120 configured and adapted for the user's left hand, and a right hand controller 120 configured and adapted for the user's right hand. The user interface 140 comprises, for example, one or more buttons, joysticks, triggers, or the like configured to enable the user to interact with the AR system 100 by providing inputs.

The sensors 144 of the hand controller 120 comprise one or more accelerometers configured to measure linear accelerations of the hand controller 120 along one or more axes and/or one or more gyroscopes configured to measure rotational rates of the hand controller 120 along one or more axes as user moves their hands and arms.

The hand controller 120 further includes one or more transceivers (not shown) configured to communicate inputs from the user to the processing system 112. In some embodiments, rather than being grasped by the user, the hand controller 120 are in the form of at least one glove, which is worn by the user and the user interface includes sensors for detecting gesture-based inputs or the like. The hand controller 120, in one embodiment, is provided as an Oculus Touch controller.

In FIG. 1, the processing system 112 comprises a processor 160, a memory 164, and a Wi-Fi module 168. The memory 164 is non-transitory hardware device that is configured to store data and program instructions that, when executed by the processor 160, enable the AR system 100 to perform various operations described herein. The memory 164 is any type of device capable of storing information accessible by the processor 160, such as a memory card, ROM, RAM, hard drives, discs, flash memory, or any of various other computer-readable medium serving as data storage devices, as will be recognized by those of ordinary skill in the art. Additionally, the processor 160 includes any hardware system, hardware mechanism or hardware component that processes data, signals or other information. The processor 160 may include a system with a central processing unit, graphics processing units, multiple processing units, dedicated circuitry for achieving functionality, programmable logic, or other processing systems.

The processing system 112 further comprises one or more transceivers, modems, or other communication devices configured to enable communications with various other devices. Particularly, in the illustrated embodiment, the processing system 112 comprises the Wi-Fi module 168. The Wi-Fi module 168, which is also referred to herein as a network adapter, is configured to enable communication with a Wi-Fi network and/or Wi-Fi router (not shown) and includes at least one transceiver with a corresponding antenna, as well as any processors, memories, oscillators, or other hardware conventionally included in a Wi-Fi module. The processor 160 is configured to operate the Wi-Fi module 168 to send and receive messages, such as control and data messages, to and from a Wi-Fi network, a Wi-Fi router, the AR headset 116, the hand controller 120, and the Internet. In certain embodiments, other communication technologies, such as Ethernet, Bluetooth, Z-Wave, Zigbee, or any other wired or radio frequency-based communication technology can be used to enable data communications between devices in the AR system 100.

In an exemplary embodiment, the processing system 112 is provided as laptop computer, a desktop computer, or any other type of discrete computer that is configured to communicate with the AR headset 116 and the hand controller 120 via one or more wired or wireless connections. In a specific embodiment, the processing system 112 is a battery-powered backpack computer operably connected to the AR headset 116 and the hand controller 120, which provides the user with high mobility. In a different embodiment, the processing system 112 is integrated with the AR headset 116 and worn on the head of the user. Moreover, the processing system 112 may incorporate server-side cloud processing systems. The cloud processing system may provide the computing power to implement any processing task of the corresponding AR system 100 and method of operation.

The program instructions stored on the memory 164 include an animation authoring program 174 that includes an AR graphics engine 178 and a disassembly algorithm 182. As discussed in further detail below, the processor 160 is configured to execute the animation authoring program 174 to enable the user to author the instructional animations 106 in AR, VR, and video-based media formats. Specifically, the animations 106 may be both authored and used in practice in the AR/VR environment. In one embodiment, the animation authoring program 174 is implemented with the support of Microsoft Mixed Reality Toolkit (“MRTK”), Final IK, and mesh effect libraries 2 3 4. In another embodiment, the animation authoring program 174 includes an AR/VR graphics engine 178 (e.g., Unity3D engine (including Unity Engine Physics-based Simulator), Oculus SDK), which provides an intuitive visual interface for the animation authoring program 174. Particularly, the processor 160 is configured to execute the AR/VR graphics engine 178 to superimpose on the display screen 128 graphical elements for the purpose of authoring AR interactions. In the case of a non-transparent display screen 128, the graphical elements may be superimposed on real-time images/video captured by the camera 124 (i.e., a video passthrough approach).

The virtual model 108, that is stored in the memory 164, is a digital model of the assembly 104 that includes virtual objects 184 that correspond directly to the physical objects 188 (i.e., real-world objects) of the assembly 104 (the real-world assembly 104). Thus, by viewing the animation 106 of one or more virtual objects 184, the user understands the relationship between the one or more corresponding physical objects 188.

### Methods for Authoring Interactive Mechanical Assembly Animations

A variety of methods, workflows, and processes are described below for enabling the operations and interactions of the AR system 100. In these descriptions, statements that a method, workflow, processor, and/or system is performing some task or function refers to a controller or processor (e.g., the processor 160) executing programmed instructions (e.g., the authoring program 174, the AR/VR graphics engine 178, or any other instructions in the memory 164) stored in non-transitory computer readable storage media (e.g., the memory 164) operatively connected to the controller or processor to manipulate data or to operate one or more components in the AR system 100 to perform the task or function. Additionally, the steps of the methods may be performed in any feasible chronological order, regardless of the order shown in the figures or the order in which the steps are described.

Additionally, various AR graphical user interfaces are described for operating the AR system 100. In many cases, the AR graphical user interfaces include graphical elements that are superimposed onto the user's view of the outside world or, in the case of a non-transparent display screen 128, superimposed on real-time images/video captured by the camera 124. In order to provide these AR graphical user interfaces, the processor 160 executes instructions of the AR graphics engine 178 to render these graphical elements and operates the screen 128 to superimpose the graphical elements onto the user's view of the outside world or onto the real-time images/video of the outside world. In many cases, the graphical elements are rendered at a position that depends upon positional or orientation information received from any suitable combination of the sensors 132, 144 and the camera 124, so as to simulate the presence of the graphical elements in real-world the environment. However, it will be appreciated by those of ordinary skill in the art that, in many cases, an equivalent non-AR graphical user interface can also be used to operate the authoring program 174, such as a user interface provided on a further computing device such as laptop computer, tablet computer, desktop computer, or a smartphone.

Moreover, various user interactions with the AR graphical user interfaces and with interactive graphical elements thereof are described. In order to provide these user interactions, the processor 160 may render interactive graphical elements in the AR graphical user interface, receive user inputs from, for example via gestures performed in view of the one of the camera 124 or other sensors 132, 144, and execute instructions of the authoring program 174 to perform some operation in response to the user inputs.

Various forms of motion tracking are described in which spatial positions and motions of the user or of other objects in the environment are tracked. In order to provide this tracking of spatial positions and motions, the processor 160 executes instructions of the authoring program 174 to receive and process sensor data from any suitable combination of the sensors 132, 144 and the camera 124, and may optionally utilize visual and/or visual-inertial odometry methods such as simultaneous localization and mapping (SLAM) techniques.

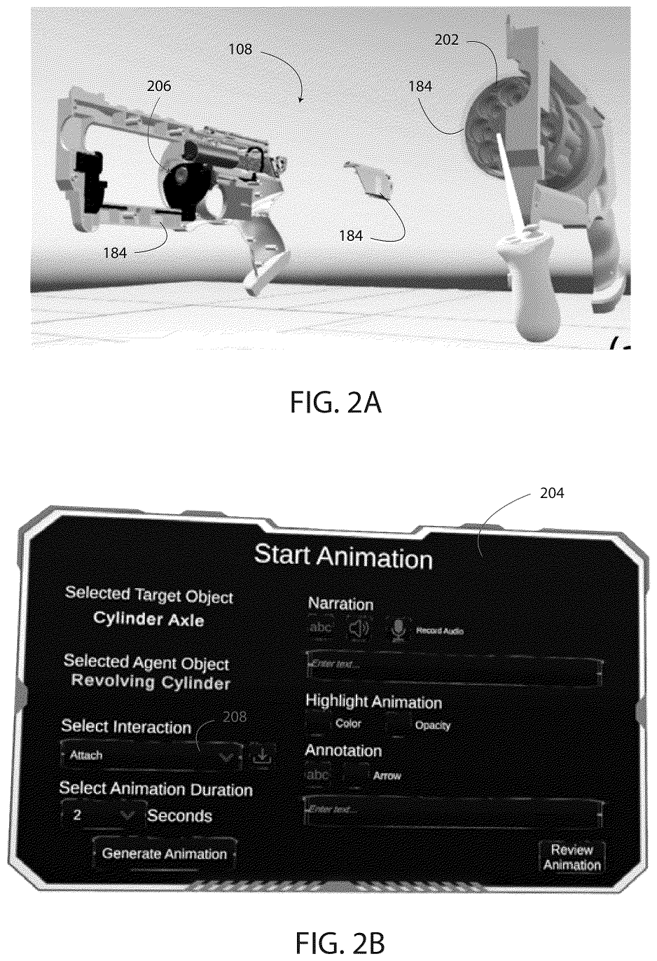

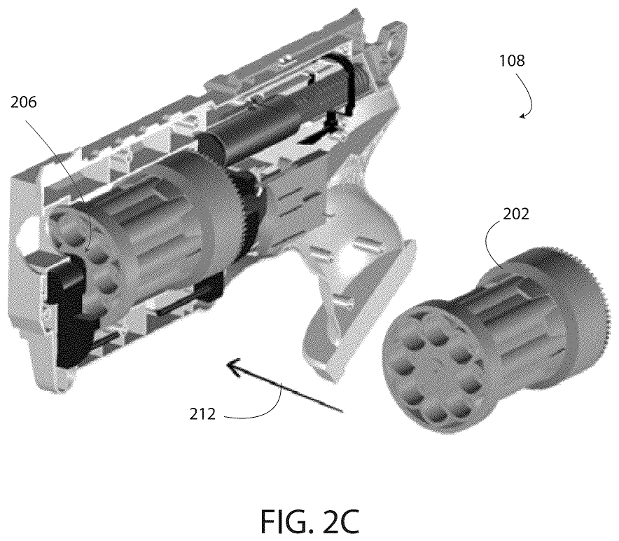

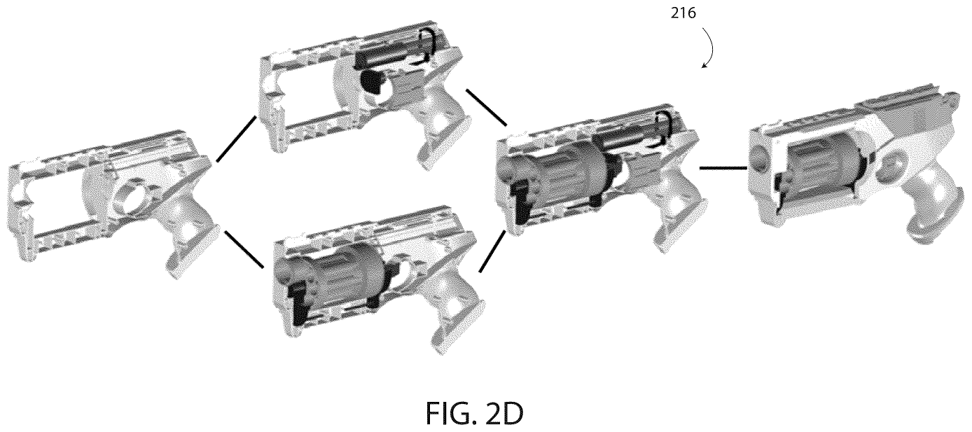

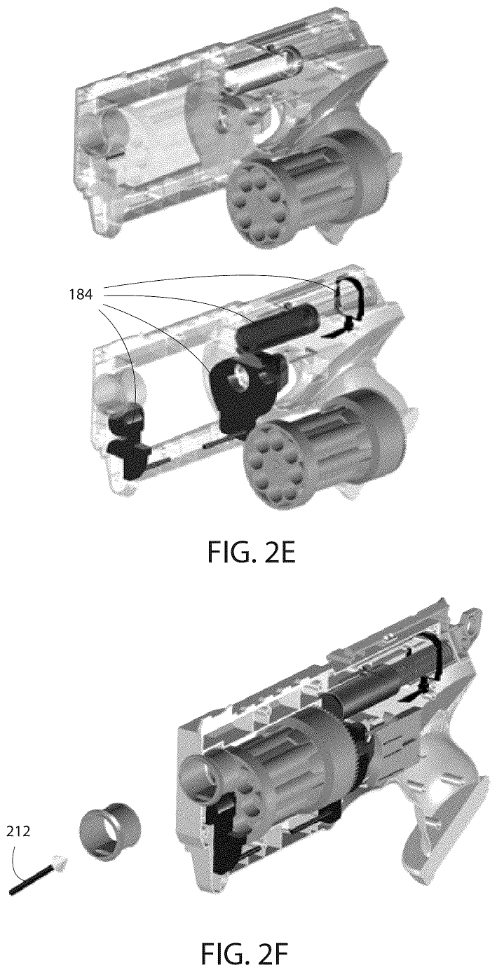

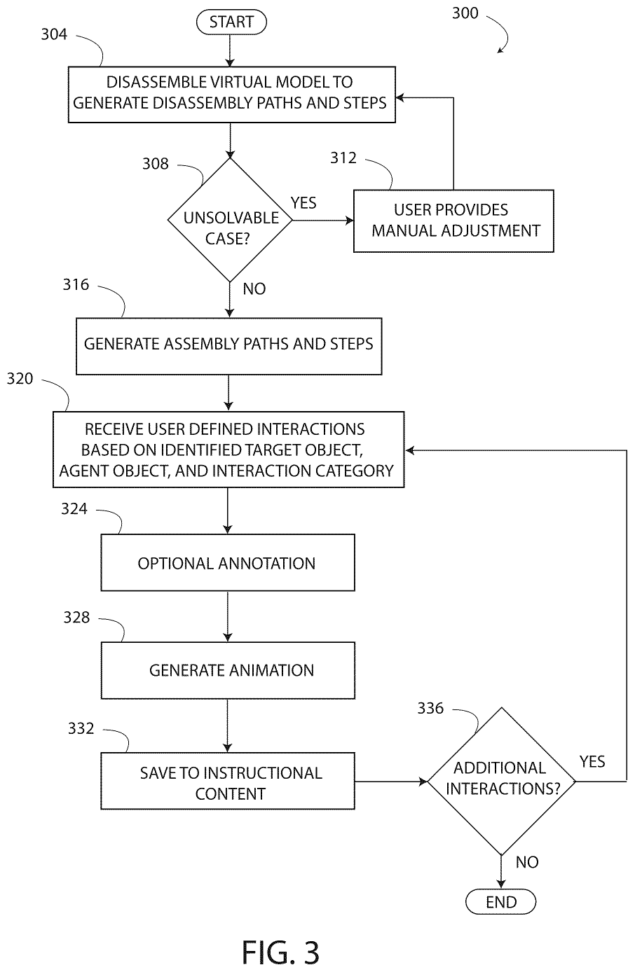

As an introduction to the method 300 shown in the flowchart of FIG. 3, a brief discussion of FIGS. 2A through 2F is provided. In this example, the assembly 104 is a toy blaster that ejects a foam projectile. FIG. 2A illustrates a virtual model 108 of the assembly 104 in an AR/VR environment in a partially-disassembled state. The virtual model 108 is shown on the screen 128 of the AR headset 116. The user interacts virtually with the virtual model 108 using the AR headset 116 and the hand controller 120 to select one or more objects 184 and/or subassemblies to animate. The object(s) 184 that is selected to animate is referred to as agent objects 202 (FIG. 2A). The object 184 that provides the reference point from which the agent object 202 is animated is referred to as a target object 206 (FIG. 2A). With reference to FIG. 2A, in this example, the user has selected an axle on which the cylinder is mounted as the target object 206, and the user has selected the cylinder that houses several of the foam projectiles as the agent object 202 to animate.

With reference to FIG. 2B, the authoring program 174 displays an animation control interface 204 that identifies the agent object 202 and the target object 206 and displays a drop menu 208 of interaction categories 210 (FIG. 1). As explained below, the interaction categories 210 assist in defining the action performed by the animation 106 to be generated. The “attach” interaction category 210 has been selected in FIG. 2B using the menu 208.

In FIG. 2C, the animation 106 is generated based on the input data to the animation control interface 204. FIG. 2C, due to the limitations of static figures, shows the agent object 202 at the beginning of the animation 106 and also at the end of the animation 106 as “attached” to the cylinder axle of the target object 206. Moreover, an arrow is included as an annotation 212 in the animation 106 to assist a viewer in understating the direction of movement of the agent object 202.

FIG. 2D illustrates an exemplary liaison diagram 216 (also referred as a liaison graph) that provides step-by-step demonstration principles enabling user-guided animation sequences within assembly constraints. By viewing the stages of the liaison diagram 216 in 3D space, the user determines the next logical step in the assembly process. Moreover, the liaison diagram 216 prevents the user from attempting to animate an object 184 having dependencies that are not yet accounted for by other animations 106 or assembly processes. The available and unavailable objects 184 are typically distinguished by color in the liaison diagram 216 for simplicity of understanding.

FIG. 2E illustrates annotations 212 (FIG. 1) shown as a change in color and/or opacity adjustments of several selected objects 184. FIG. 2F illustrates another annotation 212 shown as an arrow depicting a movement trajectory of the cylinder object 184 to enhance instructional clarity.

Based on the above introduction, the method 300 is explained in detail with reference to the flowchart of FIG. 3.

At block 304, the method 300 includes providing the processing system 112 with the virtual model 108, which is stored in the memory 164. The virtual model 108 is received by the processing system 112 through the Wi-Fi module 168, for example.

Next at block 304, the processing system 112 utilizes the disassembly algorithm 182 to virtually disassembly the virtual model 108 from an assembled state to a disassembled state. The disassembly algorithm 182 is a physics-based assembly-by-disassembly algorithm that outputs disassembly paths and disassembly steps for each of the objects 184. The disassembly paths show how a corresponding object 184 moves from an assembled state to a disassembled state in 3D space. The disassembly steps are a prescribed order for disassembly the assembly 104. The disassembly steps are included in a disassembly sequence that includes an ordered approach for object-by-object disassembly of the assembly 104. The disassembly algorithm 182 is a mostly automated approach for implementing disassembly and assembly process planning (“DAPP”) and disassembly sequence planning (“DASP”).

During the execution of the disassembly algorithm 182, collisions between the objects 184 are detected and prevented as each object 184 is removed from the assembly 104. Accordingly, the resultant disassembly sequence is a relational data structure that indicates an approach for disassembling the entire assembly 104 without causing collisions between the objects 184. This ensures that the animations 106 to be generated proceed in a correct and logical order. For most objects 184 included in the virtual model 108, the disassembly algorithm 182 is configured to automatically generate the disassembly path and the disassembly step.

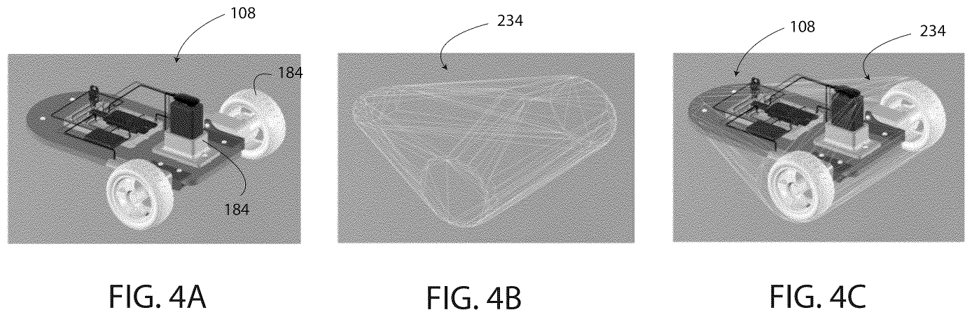

According to one approach and with reference to FIGS. 4A, 4B, and 4C, the disassembly algorithm 182 utilizes the Unity Engine Physics-based simulator to generate mesh colliders for all objects 184 of the assembly 104 and to detect collisions between object or objects 184 being disassembled. As shown in FIG. 4A, the virtual model 108 illustrates a toy car (another exemplary assembly 104) in an assembled configuration. FIG. 4B illustrates a convex hull 234 generated for collision detection for each object 184, again in the fully assembled configuration. FIG. 4C illustrates an overlay of the virtual model 108 with the convex hull 234 for each object 184 of the virtual model 108. Using the disassembly algorithm 182 and the convex hull 234 enables the processing system 112 to generate disassembly paths and disassembly steps by simulating real-world interactions and ensuring the objects 184 follow physically constrained motion paths. The disassembly process, which typically includes constrained translations and rotations of the objects 184 during disassembly, is handled effectively by this collision detection method.

In one embodiment, at block 304 the disassembly algorithm 182 handles the disassembly path planning as a tree search problem. Starting from the fully assembled state so, the disassembly algorithm 182 iterates over a predefined action space A, which includes six translational actions {[±Δx, 0, 0], [0, ±Δy, 0,], [0, 0, ±Δz]} and six rotational actions {[Δqₓ, 0, 0], [0, ±Δq_{y}, 0,], [0, 0, ±Δq_{z}]}. The disassembly algorithm 182 maintains a queue Q of possible states and iterates through the action space A until a valid disassembled state sₙ is found. A state s is represented as a combination of a 3×1 displacement vector p and a 4×1 rotation vector R. A state sⁱ is valid as long as the object 184 does not collide with any other object 184 along the disassembly path. A state sⁱ is defined as a disassembled state when the convex hull of a corresponding object i at state sⁱ does not collide with the convex hulls of the remaining objects 184 (FIG. 4B).

The disassembly algorithm 182 checks the translational similarity using the Euclidean distance ∥pₐ_{ₜ}−p_{b}_{ₜ}| and rotational similarity using the geodesic distance

$$‖ ln ( {R}_{{a}_{r}}^{- 1} {R}_{{b}_{r}} ) ‖$$

between two states sⁱ. All valid states sⁱ from the assembled state so to the disassembled state sₙ are stored as a disassembly path P, where P=s₀, . . . , sₙ.

Moreover, during the disassembly at block 304, the authoring program 174 uses a breadth-first search (“BFS”) strategy to identify valid disassembly paths by iterating over predefined actions for each object 184. These actions include translations along three axes and rotations in three planes, simulating real-world movements and ensuring the disassembly follows logical motion constraints. By relying on a physics-based planner, the authoring program 174 ensures that the generated paths respect the physical properties of the assembly and avoid collisions.

For example, in one embodiment, the processing system 112 implements the BFS strategy to identify the disassembly sequence

$${P}_{D} = \{ {P}_{D}^{1} , … , {P}_{D}^{N} \} ,$$

ensuring that the objects 184 are disassembled in a physically feasible order. The above disassembly sequence, comprised of a plurality of disassembly steps, adheres to logical and physical constraints, accounting for precedence relationships between parts during complete disassembly of the assembly 104 object-by-object.

In one embodiment, the disassembly algorithm 182 simulates (or attempts to simulate, see block 308) the motion of each object 184 from a fully assembled state to a fully disassembled state, generating physically plausible disassembly paths and disassembly steps for at least most of the objects 184. This automation allows users to focus on the larger assembly process while the authoring program 174 handles the majority of repetitive and technical tasks. Given the virtual model 108 (i.e., a CAD assembly), the disassembly algorithm 182 generates disassembly paths that position each object 184 into a dissembled position in 3D space, closely reflecting the ground truth.

The disassembly algorithm 182, in one embodiment, relies on the following assumptions to simplify the generation of the disassembly paths. First, all objects 184 in the assembly 104 are treated as rigid bodies with fixed geometries. Second, a two-part interaction approach is applied in which the disassembly algorithm 182 determines the direct interactions between two objects 184 at any given time, with no multi-object dependencies. Third, given the high accuracy of the virtual model 108, the disassembly algorithm 182 assumes that the provided assembly states are valid and correct, and that no further assembly validation is required. That is, it is assumed that the virtual model 108 is an accurate representation of the assembly 104. Fourth, the disassembly algorithm 182 primarily focuses on motion-level planning, disregarding effects from external forces like gravity or friction on the objects 188 during assembly and disassembly planning. The authoring program 174 may be configured to use any or none of the above-described assumptions in executing the disassembly algorithm 182.

As block 308 of the method 300, as alluded to above, when working with a complex virtual model 108 the disassembly algorithm 182 encounters complex scenarios that cannot be resolved automatically. The complex scenarios are referred to as unsolvable cases. The cases are “unsolvable” in the sense that the disassembly algorithm 182 cannot automatically determine a valid disassembly path and/or a valid disassembly step for an object 184. A “valid” disassembly path and/or disassembly step is one that is free from collisions of the corresponding hull meshes. Therefore, the unsolvable case includes at least one invalid disassembly path and/or an invalid disassembly step. Additionally, an unsolvable case having an invalid disassembly path and/or an invalid disassembly step may occur when multiple objects 184 need to move simultaneously or when deformable objects 184, such as springs, are involved. The unsolvable case, however, can be solved with human intervention.

In particular, while the disassembly algorithm 182 is effective to generate the disassembly paths and the disassembly steps for most objects 184, fully automating DAPP and DSP remains challenging for complex configurations of objects 184. Accordingly, when the disassembly algorithm 182 encounters an unsolvable case, the authoring program 174 prompts the user to intervene and make manual adjustments. Users can treat a plurality of objects 184 resulting in the unsolvable case as a subassembly, or the objects 184 of the subassembly can be adjust individually using the interaction categories including translate, rotate, scale, or freeform, with all adjustments recorded to ensure accurate disassembly planning. This hybrid approach balances automation with user intervention, providing a scalable solution that automates most of the process while allowing flexibility for complex or non-standard scenarios. Moreover, the hybrid approach allows the processing system 112 to automate simpler disassembly path generation processes while enabling user intervention for more complex assembly path generation that results in the unsolvable cases. The approach for disassembly is referred to as being “hybrid” because both automated disassembly and user input disassembly is utilized.

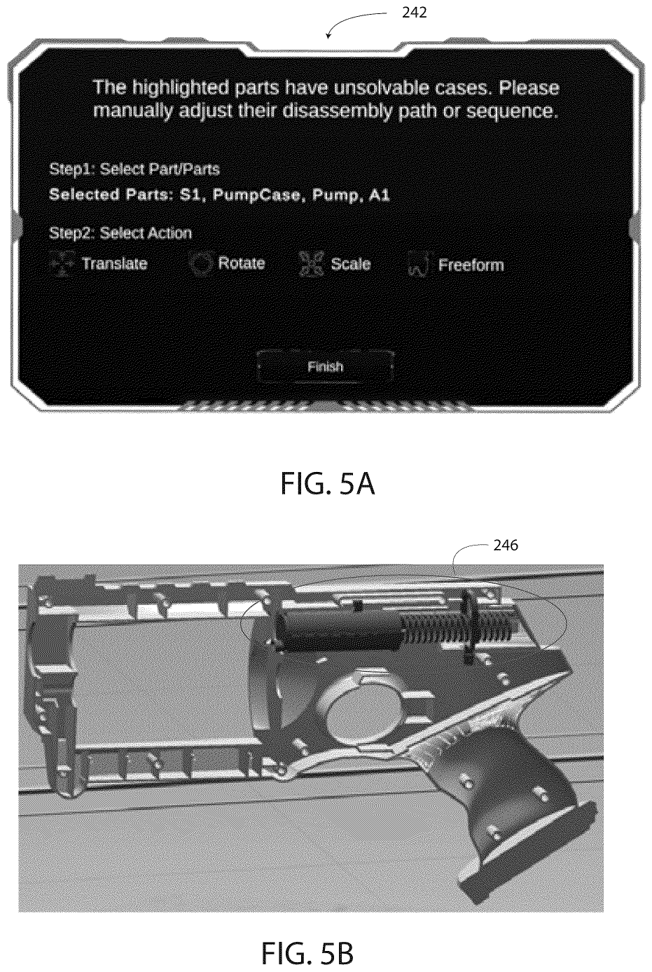

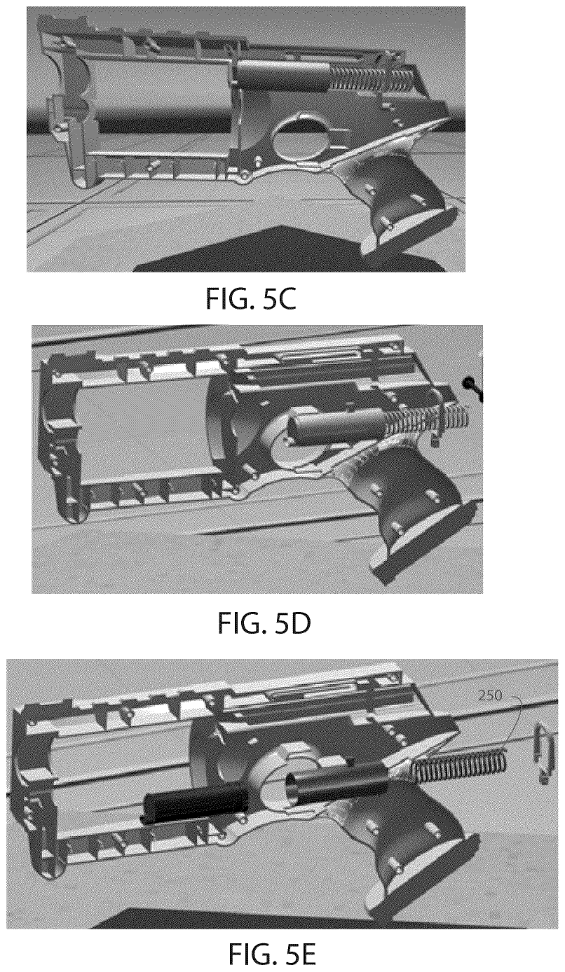

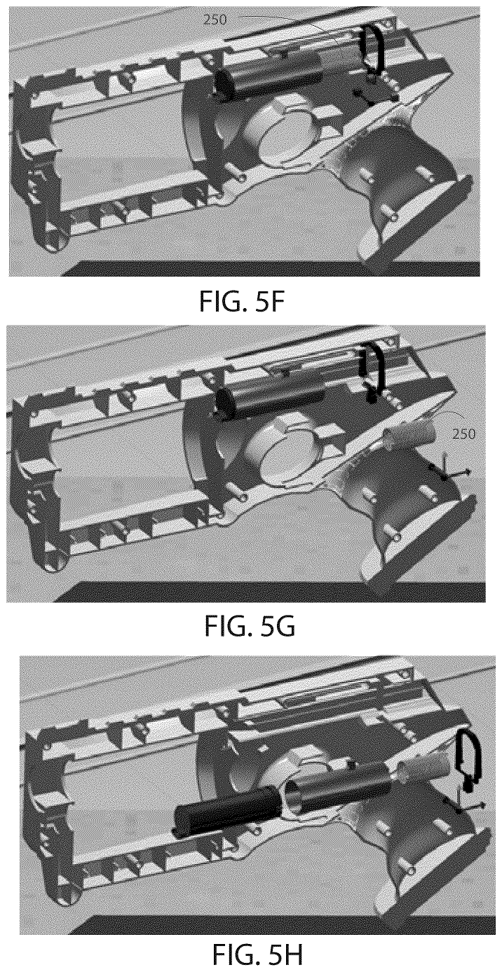

At block 312, the method 300 handles an unsolvable case for which a disassembly path and a disassembly step could not be automatically generated by the disassembly algorithm 182. In one embodiment, the authoring program 174 identifies an unsolvable case when each discoverable disassembly path for an object 184 results in a collision of the convex hull of that object 184 with at least one other convex hull of at least one other object 184. The authoring program 174 tries each available disassembly path and when none are successful without collisions, then the authoring program identifies the unsolvable case. An example of this workflow is described with reference to FIGS. 5A through 5H.

At FIG. 5A, when the disassembly algorithm 182 identifies an unsolvable case, the authoring program 174 causes an unsolvable interface 242 to be shown on the screen 128. The unsolvable interface 242 prompts the user to manually adjust the corresponding disassembly path and disassembly step for the object or objects 184 resulting the unsolvable case. The unsolvable interface 242 indicates at Step 1 the objects 184 that have been identified as resulting in the unsolvable case. The exemplary objects 184 of the toy blaster are identified as spring S1, PumpCase, Pump, and A1. The unsolvable objects 246 resulting in the unsolvable case are circled in FIG. 5B. At Step 2 of the unsolvable interface 242, the user is requested to select a corresponding action for overcoming the conflict/collision that has resulted in the unsolvable case. Exemplary actions include translate, rotate, scale, and freeform. A corresponding action is selected either individually or collectively for each of the identified objects 184. Thus, in response to identifying the unsolvable case, the authoring program 174 prompts for user inputs to overcome the conflict. Specifically, the user is prompted to provide a user input disassembly path and/or a user input disassembly step for at least one object 184 that has resulted in the unsolvable case. The unsolvable interface 242 receives this information from the user, and the authoring program 174 includes the user input disassembly path and/or a user input disassembly step in the plurality of disassembly paths and the disassembly sequence.

With reference to FIG. 5B, along with showing the unsolvable interface 242, the authoring program 174 also updates the showing of the virtual model 108 to highlight the objects 184 listed in Step 1 of the unsolvable interface 242. For example, the unsolvable objects 184 are highlighted in red. In FIG. 5B, the circled unsolvable objects 184 form a subassembly of objects 184.

Next, as shown in FIGS. 5C and 5D to overcome the unsolvable case, the hand controller 120 is operated to select the unsolvable objects 184. In FIG. 5C, the unsolvable objects 184 have been selected as a subassembly or unit by the user. In FIG. 5D, the “translate” action is applied to the selected subassembly to move the unsolvable objects 184 along an axis away from the remainder of the assembly 104.

Next, the unsolvable interface 242 prompts to user to provide at least one user input disassembly path for each object 184 included in the subassembly of unsolvable objects 184. In FIG. 5E, the user has identified and selected the translate interaction category 210 to separate of each object 184 of the subassembly along a corresponding axis. For example, the user selects each object individually in a sequence that results in disassembly of the subassembly without conflicts or collisions. The authoring program 174, binds the selected interaction category 210 and the resultant disassembly path to the corresponding object 184 to overcome the unsolvable case for that particular object 184. A spring 250 of the subassembly is identified in FIG. 5E as the unsolvable object 184.

As another response to overcoming an unsolvable case, at FIG. 5F the hand controller 120 is utilized to select only the spring 250. Then, using the unsolvable interface 242, the “scale” action is selected to “compress” virtually the spring 250 along a corresponding axis. When compressed, the spring 250 is removable from the subassembly of unsolvable objects 184 without causing conflicts or collections. In FIG. 5G, it is shown that the “translate” action has been used to separate the compressed spring 250 from the subassembly.

With reference to FIG. 5H, the remaining objects 184 of the subassembly of unsolvable objects 184 are disassembled one-by-one using the “translate” action and multiple instances of the unsolvable interface 242. The authoring program 174 records all manual adjustments, and captures the disassembly paths and disassembly steps of each object 184 that is manually adjusted by the user.

The manual disassembly paths and disassembly steps from the unsolvable cases are combined with the automatically-generated disassembly paths and disassembly steps to form a complete set of disassembly paths and the disassembly sequence for completely disassembling the assembly 104 depicted in the virtual model 108, from the assembled state to the disassembled stated. Thus, when the method 300 transitions out of block 308, the processing system 112 has developed an exploded version of the virtual model 108 that shows each object 184 in the disassembled state in 3D space.

Next, at block 316 of the method 300, the authoring program 174 uses the disassembly paths and the disassembly sequence to generate corresponding assembly paths and an assembly sequence including a plurality of assembly steps. According to one approach, the authoring program 174 reverses the disassembly paths and the disassembly sequence to generate the assembly paths and the assembly sequence. By reversing the disassembly paths and the disassembly sequence, the authoring program 174 arrives an ordered and sequential approach for building the assembly 104 from the disassembled state to the assembled state, according to the ABD approach. An assembly path and an assembly step is generated for each object 184. The method 300, however, improves on the standard ABD approach in several ways; namely, through the use of interaction categories 210, as described below.

For example, a disassembly path moves an object 184 from a first position to a second position along an axis in a first direction. Reversing the disassembly path to generate the assembly path includes moving the object along the axis in a second direction that is opposite to the first direction from the second position to the first position. A disassembly sequence includes steps A, B, and C. Reversing the disassembly sequence to generate the assembly sequence includes presenting the steps in the opposite order of C, B, and A in the assembly sequence.

At block 316 any other approach for generating at some of the assembly paths and assembly steps may be utilized by the authoring program 174. The assembly steps are the individual ordered steps included in the assembly sequence.

Also at block 316, the method 300, in some embodiments, includes a binding process in which each assembly path is automatically bound to at least one predetermined interaction category 210. Thus, each assembly path is automatically provided with a corresponding predetermined interaction category 210 during the generation of the assembly paths and the assembly sequence. The specific types of predetermined interaction categories 210 are described below in connection with block 320. For example, at block 316, when an assembly path is bound to both the translation interaction category 210 and the rotation interaction category 210 (i.e., at least one predetermined interaction category 210), the authoring program 174 labels the interaction associated with the assembly path as “screwing” or similar, for example.

Next, at block 320 the authoring program 174 enables the user to enhance the assembly paths generated at block 316 by applying animation principles, such as step-by-step demonstrations, narration highlighting key actions, and annotations to improve the clarity and instructional value of the animations 106. The authoring program 174 also allows the user to generate custom animations 106 by specifying custom assembly paths and assembly steps for any object 184 or subassembly of objects 184 as identified by the user.

The assembly animation authoring process begins with the user viewing the 3D exploded version of the disassembled assembly 104 on the screen 128 and with the user selecting a target object 206 (FIG. 2A) from the disassembled assembly 104. The target object 206 is an object of the assembly 104 that is already in an assembled position. The user makes the selection using the hand controller 120 and by pointing at the desired target object 206 within the 3D exploded assembly 104, for example. The selected target object 206 serves as the reference for initiating the animation sequence.

Next, after the target object 206 is selected, the authoring program 174 highlights all of the possible agent objects 202 (FIG. 2A) that are available to interact with the selected target object 206. The authoring program 174 determines the possible agent objects 202 based on the assembly paths and the assembly sequence. Moreover, the possible agent objects 202 are selected so as to avoid conflicts and collisions with other objects 184. The hand controller 120 is used to point at the desired agent object 202 from the possible agent objects 184, for example. That is, the user reaches with their hand to “touch” the desired agent object 202 in the 3D AR/VR environment. The possible agent object 202 are displayed differently from the other objects 184 so that the user can more easily make the selection. For example, the possible agent objects 202 are highlighted or shown in a different color in the 3D space.

With reference again to FIG. 2B at block 320, after selecting the agent object 202, the animation control interface 204 (i.e., a floating menu in the 3D space of the AR/VR environment) appears on the screen 128. This menu provides (i) an interaction menu of possible interactions (e.g., insert, attach, scale, rotate) based on the interaction categories 210, and (ii) a duration menu providing options for defining the animation duration. To define the animation 106, the user selects at least one predetermined interaction category 210 from the interface 204 to be applied (i.e., bound) to the agent object 202. In some instances the user selects just one interaction category 210 to bind to the agent object 202. In other instances the user selects more than one interaction category 210 and the authoring program 174 combines the corresponding interactions so that the agent object 202 performs each interaction of the selected interaction categories 210. For example, an agent object 202 may be required to translate along an axis and also rotate about the axis by a predetermined angle amount during the animation 106. By selecting both the translate and the rotate interaction categories, the user has quickly and easily defined the animation 106.

The animation duration specifies how long the agent object 202 will take to move from a starting state (i.e., the disassembled state) to the final state (i.e., the assembled state). As explained below, the animation control interface 204 also includes an annotation menu with several different options including narration, highlighting, and annotations with text and/or arrows. After, the user provides an identification (i.e., selects) at least one corresponding predetermined interaction category 210 and the duration, the animation 106 implementing the identified at least one corresponding predetermined interaction category of the agent object 202 and the target object 206 is generated at block 324 by the processor 160. This workflow is repeated (as indicated by block 336) for each object-object interaction until the entire assembly animation is completed.

The authoring program 174 simplifies the animation authoring process through the predefined interaction categories 210 included in the animation control interface 204. Each assembly animation 106 is represented as an interaction between the agent object 202 (the part being animated) and the target object 206 (the part already in place). By leveraging the physics-based model to guide the assembly sequence, the authoring program 174 automatically determines feasible and correct paths for most objects 184, while allowing users to manually intervene for more complex subassemblies that require additional adjustments.

In one embodiment, after the user identifies the agent object 202 and the target object 206, the authoring program 174 recommends possible interactions based on the interaction categories 210, thus minimizing the complexity typically associated with animation creation. That is, as described above, during the generation of the assembly paths, each assembly path is assigned a corresponding predetermined interaction category 210. The interaction category that is already bound to the agent object 202 is presented in the animation control interface 204 as a recommended predetermined interaction category 210 to further simplify the animation 106 generation process. Typically, the recommend predetermined interaction category 210 minimizes overlap between the agent object 202 and the target object 206 during the animation 106. Any other factors or criteria may be used by the authorizing program 174 to provide the recommended predetermined interaction category 210.

The predetermined interaction categories 210 are based on insights from participants of a formative study. In the formative study, participants consistently described object interactions using simple, clear action words such as “connect” or “insert” to specify the relationship between two objects 184. This pattern of using direct, action-oriented commands indicates that participants tend to perceive animations as sequences of interactions, emphasizing the dynamic relationships between components rather than their individual movements. Such observations highlight the value of designing animation tools that can effectively capture and represent these natural expressions of object interactions, potentially reducing the cognitive effort required to manually define each step. Based on these observations, the interaction categories 210 provide users with an intuitive framework for defining assembly relationships between the objects 184.

The predetermined interaction categories 210 are divided into two broad groups including spatial transformation and connection actions. The spatial transformation group includes interactions that change the position or shape of an object in 3D space. Exemplary interaction categories 210 included in the spatial transformation group include translate, rotate, and scale. The translate interaction category 210 includes translating/moving an object 184 from one position to another position along an axis. The axis is typically linear, but could also be curved. An exemplary movement according to the translate interaction category 210 is the movement of a piston in a cylinder and the movement of a drawer opening and closing. The rotate interaction category 210 including turning or spinning an object 184 around a specified axis in 3D space. An exemplary movement according to the rotate interaction category 210 is the rotation of a key inserted into a lock or the rotation of a screwdriver to drive a screw. The scale interaction category 210 includes actions that temporarily compress, expand, or deform an object 184 in 3D space so that the object 184 is ready for the assembly process, such as the expansion of the spring 250 (FIG. 5E) during the assembly process. An exemplary movement according to the scale interaction category 210 is the compression and decompression of a spring.

The connections action group of interaction categories 210 includes interactions describing how one object 184 relates to another object 184 in terms of physical attachment. Exemplary interactions included in the connection action group include insert and attach. The insert interaction category 210 is selected when one object 184 is placed into another object. An exemplary interaction in the insert interaction category 210 is inserting a battery into a correspondingly-shaped battery compartment. Algorithmically, the authoring program 174 determines that an agent object 202 is “inserted” when an agent mesh of the agent object 202 overlaps by more than 30% with a target mesh of the target object 206. The attach interaction category 210 is selected when the agent object 202 is placed onto the target object 206, with less than 30% mesh overlap between the agent mesh and the target mesh. The agent mesh and the target mesh refer at least to the convex hull 234, as described above and as used for collision detection. An exemplary interaction in the attach interaction category 210 is interlocking two LEGO® bricks. The attach interaction category 210 also includes actions such as snapping, clamping, gluing, welding, and otherwise affixing the selected objects 184.

The predetermined interaction categories 210 cover a range of common assembly types, offering a flexible yet straightforward framework for users to easily define the animations 106 without needing to manually specify every complex movement or interaction between the objects 184 using program language or more difficult methods.

Based on the above, the user identifies at least one predetermined interaction category 210 to be applied to the agent object 202. In this way, the movement and the interaction between the agent object 202 and the target object 206 is easily and quickly defined.

Next, as shown in the animation control interface 204 of FIG. 2B, the user is also able to annotate the animation 106. Several different types of annotations are available that build on the theory of cognitive load reduction. The annotations include text labels, audio narration, and object highlighting. Users can add narration directly to each animation 106, either by overlaying a label or by recording/importing audio clips. The duration of the animation 106 can be matched to the narration length, ensuring synchronization between the visual actions and the accompanying audio explanations. This aspect of the authoring program 174 caters to different learning preferences, enhancing the educational impact of the animation 106 and the animated instructional content 110 overall.

At block 324, to direct user attention to critical steps in the assembly 104, the highlighting features visually distinguish important actions, interactions, or objects 184. Techniques such as color and opacity adjustments of the objects 184 are used to call attention to certain objects 184 using Unity's dynamic material alteration functions allowing for seamless integration, for example. During each atomic instance of an animation 106, the agent object 202 can be highlighted by adjusting or changing its color or opacity, in order to highlight a movement of the agent object 202 from the disassembled state to the assembled state. The highlighting makes the agent object 202 stand out against the rest of the objects 184 (e.g., rendering non-agent objects 184 as semi-transparent). This ensures that viewers remain focused on the relevant object(s) 184 and actions throughout the animation 106.

To further enhance the instructional value of assembly animations 106, annotations 212 such as arrows and text labels are added to the animation 106 using the animation control interface 204 of the authoring program 174. Arrows are used to indicate the direction of movement of an object 184, while textual labels (i.e., text) provide additional information about the action being performed (e.g., specifying the type of screw being inserted). The authoring program 174 supports at least two types of arrows including transitional arrows and cap arrows, and automatically determines the appropriate type of arrow based on the assembly path generated during the assembly sequence, ensuring spatial coherence and correct scaling relative to the object 184. Thus, in some embodiments, the authoring program 174 is configured to automatically annotate the animation 106 with a corresponding arrow annotation 212 that indicates a direction of movement and/or an orientation of the agent object 202. The authoring program 174 automatically determines the direction and/or orientation of the arrow annotation 212 based on the corresponding assembly path and the assembly sequence associated with the agent object 202.

Text label annotations 212 are similarly aligned with the motion of the object 184 during the animation 106, enabling clear, concise communication of key information without overwhelming the viewer. Typically, the added text assists the user in assembling the assembling the agent object 202 on the target object 206. The annotations 212 are visible in 3D space and are configured to reorient themselves as the user moves the animated instructional content 110 so that the annotations 212 are always readable and always provide the correct information (such as an arrow annotation 212 that reorientates to always point in a desired direction in 3D space). By providing users with intuitive tools to apply these principles, the authoring program 174 not only streamlines the animation process but also ensures that the resulting animations 106 are clear, instructional, and aligned with best practices for educational and industrial use.

A further type of annotation that can be added to the animation 106 at block 328 includes trail lines. Trail lines illustrate movement of the object 184 with a dashed line style. Trail lines enhance the ability to visualize the movement of the object 184 in 3D space. In some embodiments of the authoring program 174, the trail lines are generated algorithmically based on the assembly paths and the assembly sequence, thereby providing users with a clearer visualization of the assembly paths and improving the overall instructional effectiveness of the instructional content 110.

A further type of annotation includes the depictions of hand tools during an animation 106. Mechanical assembly processes often involve hand tools, which are crucial for accurately representing real-world tasks. The authoring program 174 includes predefined animations of hand tools that can be added to an animation 106 of an object 184 to help explain how the agent object 202 is assembled onto the target object 206. For example, the authoring program 174 includes animations of hand tools including screwdrivers, wrenches, and power tools. By predefining the CAD models of the hand tools and determining an optimal position and orientation of the hand tool model, the authoring program 174 animates the hand tools to accurately depict their movements and interactions during the assembly process. The hand tool annotation enables users to create more comprehensive animations 106 that include not only the assembly components but also the tools used in the assembly process.

Next at block 328 of the method 300 after the user has entered the desired information into the animation control interface 204, the authoring program 174 generates the corresponding animation 106 based on the provided input data, the assembly path(s), the assembly sequence, the annotation data, and the predetermined interaction category 210. By simply providing information to the animation control interface 204, the user has created an animation 106 without any programming or specialized coding knowledge.

At block 332 of the method 300, the animation 106 is saved to the memory 164 as part of the assembly instructions included in the animated instructional content 110. The animated instructional content 110 includes assembly instructions comprising the complete set of assembly animations and the assembly sequence for assembling the assembly 104 from the disassembled state to the assembled state. The animated instructional content 110, depending on the embodiment, is viewable in the 3D space of an AR/VR environment or in a traditional 2D on a computer monitor. User views the animated instructional content 110 and then interacts with the physical objects 188 of the assembly 104. For example, and as described in more detailed below, the animated instructional content 110 could be used in an education environment to teach students about the interactions of various objects 188 of an assembly 104. The animated instructional content 110 could also be used in a repair or maintenance setting to rebuild or reassemble an assembly 104 included in a machine, such as an automobile. The animated instructional content 110 is usable in any context that requires instructing a user to interact with the objects 188 of an assembly 104.

Block 336 illustrates the iterative aspect of the method 300 that enables the user to continue back to block 320 to generate additional animations 106 for other objects 184. When the user has determined that all of the desired animations 106 have been generated the method 300 ends and the animated instructional content 110 is available for use.

During the iterative process, the authoring program 174 simplifies the user's task in deciding which object to animate next. As introduced above, FIG. 2D illustrates an exemplary interactive liaison diagram 216 (also referred to as a liaison graph) that is generated by the authoring program 174 based upon step-by-step demonstration principles enabling user-guided animation sequences within assembly constraints. By viewing the liaison diagram 216 in the AR/VR environment, the user determines the next logical step in the assembly process. That is, the liaison diagram 216 visualizes dependencies between the objects 184 and indicates which of the objects 184 is available for generating an animation 106 based on the assembly constraints and conflicts according to the previously-determined assembly paths and the assembly sequence. The liaison diagram 216 showcases the various stages of assembling the assembly 104, highlighting the flexibility and user control in the process while maintaining the constraints of the assembly sequence, starting from Stage 1 to the final assembled state in Stage 4. The various stages of the liaison diagram 216 may be color coded to assist in helping the user understand which objects 184 and subassemblies are available for a next animation step. Currently unavailable objects 184 and subassemblies are represented differently from the available objects 184 and subassemblies. The liaison diagram 216 enables users to keep track of the assembly progress and plan subsequent interactions effectively.

### Formative Study, Summative Study, and Results

To guide the design of the AR system 100 and better understand the pain points users face when authoring assembly animations, the above-mentioned formative study was conducted aimed at identifying key challenges with current animation tools. The results of the formative study were used to derive the design requirements for the AR system 100. The developed AR system 100 was then evaluated in a summative study, which is described below.

In the formative study six participants were recruited including four professionals (A1-A4) experienced in CAD-generated animations using SolidWorks and Fusion 360, and two animators (A5-A6) proficient in CAD tools such as SolidWorks and Creo with AR/VR development experience. A5 had prior experience in AR development, while A6 specialized in VR development, both using Unity for AR/VR projects. Their expertise provided insights into the workflow challenges they faced when creating assembly instructions with current tools.

As a methodology, participants were asked to reflect on their experiences with assembly animation tools, focusing on their typical workflow, the challenges they face, and how they handle complex assemblies. They were also asked whether they followed any guidelines or checklists to ensure the effectiveness of their animations. Additionally, the participants were presented with a CAD assembly of a toy car (such as the toy car of FIG. 4A) and requested that they outline their typical workflow and provide text prompts to generate the animation, imagining if the system could generate the animation entirely based on text prompts. This provided an understanding in how expert users naturally conceptualize the assembly animation process, which would guide the development of a more efficient workflow.

Through interviews and task-based evaluation, several key pain points and opportunities for improving the assembly animation process were identified. Expert users highlighted the steep learning curve and significant time investment required to create assembly animations using tools like SolidWorks, Fusion 360, Blender, and Unity. Users noted that while each tool offers some flexibility, the manual setup of part interactions frequently led to errors and extended setup times. For instance, A2 found the camera view management in Fusion 360 cumbersome: “ . . . camera view selection is effortless but a bit troublesome. I often end up recording unintended views and have to redo the steps frequently”. A3, referring to SolidWorks, mentioned that the manual keyframing for camera views is “ . . . time-consuming and requires setting up geometries just for target points”. For more complex assemblies, participants expressed frustration with managing relationships between multiple parts. A1 shared: “For assemblies with dozens of parts, it (Fusion360) becomes really clunky, managing relationships between parts is a nightmare”. Blender users, like A4, found the tool's interface overwhelming and its hierarchy management insufficient: “Blender doesn't even have a proper way to deal with complex hierarchies. You have to create your own layers and hope you remember what's what”. Unity is script-intensive, with A6 stating: “I spend more time fixing errors, assigning references than actually creating animations”. While some participants appreciated the traditional tools' capabilities, the overall consensus was that traditional tools lack intuitive features for animation authoring and demand high technical proficiency and/or time commitment.

The formative study aimed to explore how users naturally describe mechanical assembly animations, focusing on the language they use to articulate interactions between parts. This investigation revealed that participants consistently employed simple, clear action verbs such as “connect”, “insert”, and “place” to define relationships between components. For instance, A1 remarked, “ . . . connect the wheel to the DC Motor”, and A3 described, “ . . . insert the battery inside the battery mount”. This pattern of using direct, action-oriented commands indicates that participants tend to perceive animations as sequences of interactions, emphasizing the dynamic relationships between components rather than their individual movements. Such observations highlight the value of designing animation tools that can effectively capture and represent these natural expressions of component interactions, potentially reducing the cognitive effort required to manually define each step.

During the formative study, participants acknowledged relying on their own heuristics to create visually coherent animations, with no structured set of principles or guidelines in place. A1 mentioned maintaining consistent speed: “ . . . tried to keep a consistent speed for the animations so it doesn't feel rushed or too slow”. A6 emphasized avoiding overlap between parts: “ . . . made sure there was no overlap or clipping between the parts” A2 and A4 focused on ensuring sequential order: “ . . . the sequence of movements should make logical sense—no jumping around or out-of-order actions”. A3 discussed minimizing camera movement to avoid viewer disorientation: “ . . . kept camera movements to a minimum so viewers wouldn't get disoriented while watching the animation”, but acknowledged this often resulted in occlusions and limited visibility of certain parts. Although some informal rules were shared, participants unanimously recognized the lack of a structured approach. A5 noted: “I just try different things and see what works, but there's no rulebook or checklist to follow”. A2 similarly stated: “ . . . you're basically guessing what looks good. There's no structured way to evaluate the animation”. This lack of standardized guidelines highlights the need for a systematic approach to mechanical assembly animation design, a finding supported by previous work in the field.

From the insights gathered during the formative study, the following design requirements were identified. Automate the assembly path and assembly sequence planning. The manual processes highlighted by the participants resulted in the design requirement to simplify the animation authoring process through automation. By automating key aspects of the workflow, particularly the assembly sequence generation, efficiency is improved, especially for complex assemblies. Simplify component interaction: The recurring pattern in the formative study underscored the need to streamline how users specify interactions between components. Provide guiding principles for effective animation. Based on the formative study users needed a standardized framework to ensure the effectiveness of their animations.

After the development of the AR system 100 the summative study was conducted to evaluate the effectiveness of the AR system 100 in comparison to traditional software tools, focusing on ease of use, efficiency in authoring VR assembly animations, and the impact of employing the predefined interaction categories 210. The aim of the summative study was to understand the potential of the AR system 100 to streamline the animation authoring process and improve user experience by facilitating precise animation specifications, as opposed to free-form input methods. The summative study design draws on insights from prior research on various authoring tools.

The summative study involved eleven users distributed across two age groups: 18-24 years (2 users) and 25-32 years (9 users), with varying levels of experience in generating assembly animations. Six professional users (P1, P2, P3, P4, P5, P6, P9, P10) had over five years of experience using CAD software and Unity for animation creation, while two novice users (P7, P8, P11) were proficient in CAD software such as SolidWorks and Fusion360 but had beginner-level experience in creating CAD animations.

The summative study utilized a VR environment using the Oculus Quest 2 as the hardware for operating the AR system 100, while the baseline condition of the formative study was tested on a PC using traditional software. Each session, lasted between 1.5 and 2.0 hours, and was structured into three phases: overview and training, the target session, and a final interview and feedback session. Before the summative study, participants completed an institutional review board (“IRB”) approved consent form and a pre-study questionnaire.

During the overview and training session, participants were introduced to the principles of assembly animation via PowerPoint slides, images, and videos. This was followed by a step-by-step tutorial of the AR system 100 presented through VR demonstrations to ensure the participants were familiar with the system's operation.

In the target session, participants were asked to generate assembly animations 106 for two distinct assemblies 104 in two conditions: a baseline condition using traditional 3D CAD software, Unity, or Unreal, and a condition using the AR system 100. The baseline condition software was chosen by participants based on their familiarity. Four professional users (P1, P2, P3, P4, P5) chose Unity, two users P7 & P11 opted for SolidWorks, while P6, P8, P9, & P10 selected Fusion360. The same assemblies 104 and instructions were provided to all participants in both conditions. The order of conditions was counterbalanced using a Latin-square design, with no time limits imposed for either condition. Finally, the summative study concluded with the interview & feedback session where participants shared their experiences and completed a post-study questionnaire, offering insights on various aspects of the system. The summative study provided an opportunity to compare the AR system 100 directly with traditional tools and evaluate its effectiveness in enhancing the animation authoring process for VR environments.

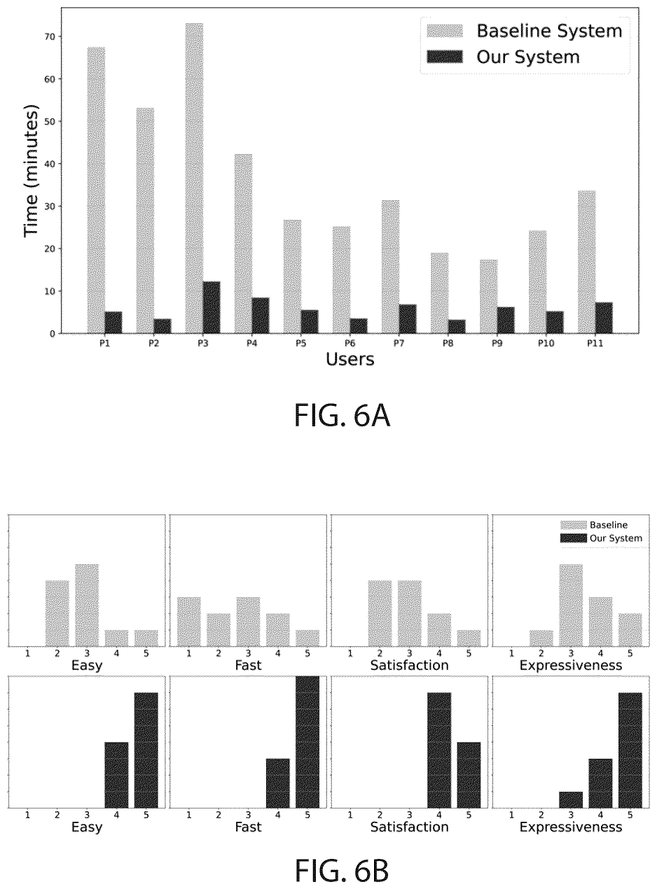

On average, participants completed the target session in 37.5 minutes (SD=19.1) using the baseline software, while use of the AR system 100 significantly reduced the time to 6.1 minutes (SD=2.6). A paired t-test confirmed that the difference in completion times was statistically significant, t(10)=5.8, p<0.001. These results, as illustrated in FIG. 6A, indicate that the AR system 100 facilitates faster and more efficient animation authoring compared to traditional tools.

FIG. 6A shows the time in minutes taken by participants to complete the animation authoring task using the baseline system and using the AR system 100. FIG. 6B illustrates a comparison of user ratings between the AR system 100 and the baseline system across four categories.

In a questionnaire included in the summation study and summarized by FIG. 6B, participants evaluated both systems using a 5-point Likert scale on four criteria: ease of use, speed of animation, overall satisfaction, and expressiveness fulfillment. In the 5-point Likert Scale 1=strongly disagree to 5=strongly agree. Wilcoxon Signed-Rank tests revealed significant differences in favor of the AR system 100 across all criteria. Participants found the AR system 100 significantly easier to use (p<0.005), faster to operate (p<0.001), more satisfying (p<0.005), and more expressive in creating assembly animations (p<0.01) compared to the baseline condition. These results indicate that the AR system 100 provides an enhanced user experience for authoring animations in virtual environments. The cohort of expert and novice mechanical assembly animators found the AR system 100 to be beginner-friendly. Users who used CAD software (P6, P7, P8, P9) were generally relieved that they did not have to manage camera events, a common issue in traditional animation software where users must manually adjust the camera to avoid occluded views. As noted by P6, a Fusion 360 user: “ . . . it's just extra work navigating to the correct angle by adjusting the camera, while here (Virtual Reality) I can just move and rotate the animation . . . ”. Similarly, P7 & P11, who used SolidWorks, spent more time than Fusion 360 users due to the additional complexity of manually setting camera keyframes. This ability to interact directly with the animation in 3D space without worrying about fixed camera events was well-received, adding to the ease of use for users when generating assembly animations.

Users who had prior experience with Unity (P1, P2, P3, P4, P5) appreciated the automatic explosion of the assembly 104 in the AR system 100 as is provided by the disassembly algorithm 182 at block 304 of the method 300. P3 stated, “If not for this (automated solver), I had to manually move parts and record their transform (position and orientation in Unity), write tedious scripts to move gameObjects from one position to another”. Fusion360 users (P8, P9) noted that although Fusion360's auto-explode feature was faster than the disassembly algorithm 182 of the AR system 100, Fusion360 often failed to account for constraints and moved parts randomly. P9 remarked, “ . . . it (Fusion360's auto-explode feature) is fast, but it's wrong most of the time, so I don't use this feature often when creating assembly animations”. All users appreciated the hybrid approach of the AR system 100 that automatically generates physically plausible paths and sequences for most object 184 while allowing user intervention for the unsolved cases. P7 commented, “instead of manually specifying the path for all parts like in CAD software, I was happy to do it for just the unsolved cases”, and P9 similarly stated, “ . . . although it (the AR system 100) couldn't solve the entire assembly, what it did was accurate for the rest of the parts”.

In the summation study all users praised the direct interaction with the object 184 in 3D space using the predefined interaction categories 210. P3 remarked, “ . . . the interaction categories covered everything I could possibly do in the assembly animation”. Participants (P2, P5, P6, P7) had positive reactions to the liaison diagram 216 (FIG. 2D) used to arrange parts for animation. P6 noted, “ . . . it was really clear to understand how parts are connected and which parts interact with what”, and further added, “With the graph, it was easy to keep track of how much animation was left, like a checklist to make sure I wasn't forgetting anything.” P7 specifically appreciated the rotating and revolving features, mentioning, “I wanted to animate the opening and closing of a cabinet door, and the rotate and select axis feature made it really easy.”

The above-mentioned principles for effective animation formed a basis for features of the AR system 100 for creating effective assembly animations 106. There are no baseline systems that offer these features, and users who used Fusion360 or SolidWorks in the baseline condition struggled to add highlights, annotations, and narration to their animations. P6 mentioned, “ . . . usually we record simple assembly animations from Fusion360 and edit them in video software to add narration or annotation”. During the target session, P6 attempted to use Fusion360's appearance feature to add highlights but found it unintuitive and ultimately abandoned the attempt in favor of a simple exploded view animation. P4 commented positively on the highlight feature of the AR system 100, saying, “This (highlight) feature is quite effective, particularly when it comes to blending color and opacity together”. P6 also praised the highlight functionality, noting that for complex assemblies like an IC engine, such a feature would be “invaluable”.

Participants of summative study who used Unity in the baseline condition managed to create highlights (P2, P3) and annotations (P1) through scripting, but none of the other users could implement similar features in traditional tools. All users expressed positive remarks about the expressiveness of the assembly animations 106 generated by the AR system 100. The results of the summative study confirm that the AR system 100 aligns with the initial design goals, effectively addressing key challenges in authoring VR assembly animations 106. Compared to traditional tools, the AR system 100 simplifies the process, particularly through features like predefined interaction categories 210, highlights, and annotations 212. These elements offer greater flexibility and ease in generating animations, which was appreciated by participants.

Comparison with existing tools and practices. The AR system 100 shares similarities with traditional CAD software in terms of direct object interaction (P3: “the interaction style is pretty much what I'm used to in CAD tools”), allowing users to click on and manipulate objects 184 in 3D space. However, the AR system 100 offers distinct advantages by automatically generating the disassembly path and the assembly paths using a physics-based ABD approach. Additionally, the AR system 100 supports hybrid handling of unsolvable cases and features like highlights, annotations 212, and narration—capabilities that are lacking in most traditional CAD tools (P10: “ . . . being able to add narration and guide steps through visual cues makes the whole process more engaging”). Furthermore, users do not need to manually adjust the camera, as the AR/VR environment provides an interactive view, making it easier to observe and manipulate the animation 106 from any angle.

One key area where the AR system 100 diverges from traditional tools is in managing the assembly sequence (P9: “ . . . it's nice to have the system handle which part to animate first so I don't accidentally mess up the sequence”). Unlike CAD software or Blender/Unity, where users must manually track and adjust the order of assembly operations, the AR system 100 enforces logical sequencing by automatically restricting object animation until the target object 206 is in place. This ensures consistency and reduces the chance of errors, offering a more structured and reliable approach to authoring the animations 106.

The AR system 100 simplifies authoring compared to demonstration-based methods by eliminating the need for complex setups like motion capture hardware, making it more accessible and reducing time and resource requirements. While Unity and Blender offer greater freedom and expressiveness, they also require extensive scripting and coding, whereas the visual interface of the AR system 100, as shown on the screen 128, allows users to create animations 106 without writing any code, making it more user-friendly while still enabling precise and effective assembly animations 106 (P2: “ . . . there are definitely things Unity and Blender can do better, but for a beginner, this (the AR system 100) is way more approachable”).

The AR system 100 allows users to create effective AR/VR animations 106, offering solutions in education, industrial training, assembly instructions, and many other applications.

In educational settings, the AR system 100 aids in explaining complex mechanisms, such as the toy blaster (FIG. 2A), by using animation principles like sequential narration and annotations 212 to clarify the function of each object 184. The animated instructional content 110 of the toy blaster illustrates the complexity of the assembly 104, which is informative and educational for students, designers, and other interested parties. This enhances comprehension by visually guiding learners through the assembly process.

In do-it-yourself (“DIY”) assembly, such as the assembly of flatpack furniture, the AR system 100 replaces complex manuals with step-by-step AR/VR animations 106. By highlighting key actions and adding annotations 212, the AR system 100 provides clear guidance through the assembly process, overcoming user frustration with traditional printed instructions. In operation, the person utilizes the AR headset 116 and optionally the hand controller 120 to view animated instructional content 110 that includes animations 106 and annotations 212 illustrating how to assemble the furniture (i.e., another exemplary assembly 104). The person interacts with the physical objects 188 (including a physical agent object and a physical target object) of the assembly 104 to build the furniture (or any other product) while viewing the animations 106 of the virtual objects 184 that are moved in the corresponding animations 106. As a result, the person is more easily able to identify the various objects 188 and the assembly paths used for assembling the furniture.

A further use of the AR system 100 is for assisting with maintenance processes and procedures. For example, the animated instructional content 110 depicts a maintenance process of a conveyor belt or any other product, providing a step-by-step guide for either (i) actually repairing the product in an AR/VR environment, or (ii) skill training in industrial settings for learning how to repair the product by “repairing” the product in the 3D of the AR/VR environment. Such an approach significantly reduces task times and error, while improving leaning outcomes. In another example for assisting with maintenance processes the AR system 100 includes animated instructional content 110 depicting animations 106 for changing and maintaining computer numerical controlled (“CNC”) fixtures, thereby streamlining complex industrial tasks.

### CONCLUSIONS

The AR system 100 is an interactive authoring system tailored for creating mechanical assembly animations 106 in the AR/VR environment. The AR system 100 integrates predefined interaction categories 210 and automated assembly planning to streamline the animation process for users of all skill levels. By incorporating principles of effective animation design—such as step-by-step demonstrations, dynamic highlighting, and annotation—the AR system 100 ensures that the resulting animations 106 of the animated instructional content 110 are both pedagogically sound and visually comprehensible. The results of the summative study indicate that the AR system 100 not only reduces authoring time significantly but also provides a more intuitive and accessible alternative to traditional animation tools. This positions the AR system 100 as a valuable tool for enhancing the creation and dissemination of the animated instructional content 110 in virtual environments.

The approach taken in the developing the AR system 100 moves beyond relying solely on manual demonstration or keyframe-based authoring by introducing a taxonomy of object-object interactions (“OOI”). This taxonomy, repurposed from its traditional use in scene-graph construction, facilitates the expression of animation intent, allowing users to define interactions without requiring complex setups. By integrating the disassembly algorithm 182, the AR system 100 automatically generates the necessary disassembly and assembly trajectories, offering users flexibility in customizing the animations 106. This approach simplifies the authoring process while adhering to key animation principles such as sequential narration and key action highlighting, without the need for external sensors, scripting, or complex node graphs.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for generating animated instructional content depicting assembly instructions of an assembly, the assembly including a plurality of objects, the method comprising:
disassembling a virtual model of the assembly from an assembled state to a disassembled state using a processor by executing instructions that implement a disassembly algorithm, the disassembly algorithm configured to output for each object of the plurality of objects (i) a disassembly path included in a plurality of disassembly paths, and (ii) a disassembly step included in a disassembly sequence;
generating, with the processor, for each object of the plurality of objects an assembly path and an assembly step by reversing the plurality of disassembly paths and the disassembly sequence, each assembly path included in a plurality of assembly paths, and each assembly step included in an assembly sequence;
authoring, with the processor, at least one assembly animation showing at least one agent object of the plurality of objects moving from the disassembled state to the assembled state along a corresponding assembly path of the plurality of assembly paths based on (i) an identification of at least one target object of the plurality of objects on which the at least one agent object is to be assembled, and (ii) an identification of at least one corresponding predetermined interaction category of a plurality of predetermined interaction categories; and
including the at least one assembly animation in the animated instructional content,
wherein each predetermined interaction category specifies (i) a spatial transformation of the at least one agent object relative to the at least one target object, and/or (ii) a connection action between the at least one agent object and the at least one target object.

2. The method according to claim 1, wherein the spatial transformation of the at least one agent object includes (i) translating the at least one agent object from one position to another position in 3D space, (ii) rotating the at least one agent object around a specified axis in 3D space, and/or (iii) temporarily compressing, expanding, or deforming the at least one agent object in 3D space.

3. The method according to claim 1, wherein the connection action includes (i) inserting the at least one agent object into the at least one target object, and/or (ii) attaching the at least one agent object to the at least one target object.

4. The method according to claim 3, wherein:
the connection action includes inserting the at least one agent object into the at least one target object,
the at least one agent object defines an agent mesh,
the at least one target object defines a target mesh, and
the inserting is detected algorithmically by the processor when the agent mesh and the target mesh overlap by more than 30%.

5. The method according to claim 1, wherein generating the plurality of assembly paths includes automatically binding each corresponding assembly path to at least one predetermined interaction category.

6. The method according to claim 1, wherein:
authoring the at least one assembly animation includes (i) receiving an identification of the at least one target object, (ii) determining possible agent objects of the plurality of objects that are available to interact with the at least one target object based on corresponding assembly paths and the assembly sequence, and (iii) receiving an identification of the at least one agent object as a selection from the possible agent objects, and
the possible agent objects are displayed differently from other objects of the plurality of objects.

7. The method according to claim 6, wherein:
authoring the at least one assembly animation includes displaying an animation control interface after the at least one agent object is identified, and
the animation control interface includes at least one of (i) the plurality of predetermined interaction categories, and (ii) options for defining a duration of the at least one assembly animation.

8. The method according to claim 7, wherein:
the processor determines a recommended predetermined interaction category for the at least one agent object based on the corresponding assembly path and the assembly sequence, and
the recommended predetermined interaction category minimizes overlap between the at least one agent object and the at least one target object during the at least one assembly animation.

9. The method according to claim 1, further comprising:
changing a color or changing an opacity of the at least one agent object during the at least one assembly animation in order to highlight a movement of the at least one agent object from the disassembled state to the assembled state.

10. The method according to claim 1, further comprising:
adding at least one annotation to the at least one assembly animation, the at least one annotation including text and/or audio to assist a user in assembling the at least one agent object on the at least one target object.

11. The method according to claim 10, wherein the at least one animation includes audio and the method further comprises:
synchronizing a duration of the at least one assembly animation with a duration of the audio.

12. The method according to claim 1, further comprising:
automatically annotating the at least one animation to include an arrow to indicate a direction of movement and/or an orientation of the at least one agent object during the at least one assembly animation, and
automatically determining a direction of the arrow and a type of the arrow based on the corresponding assembly path and the assembly sequence.

13. The method according to claim 1, the disassembling comprising:
identifying unsolvable cases in which the disassembly algorithm does not output a valid disassembly path and/or a valid disassembly step for at least one object of the plurality of objects;
receiving a user input disassembly path and/or a user input disassembly step for the at least one object; and
including the user input disassembly path in the plurality of disassembly paths and/or including the user input disassembly step in the disassembly sequence.

14. The method according to claim 13, wherein the user input disassembly path is manually input by binding the at least one object to another corresponding predetermined interaction category of the plurality of predetermined interaction categories as selected by a user from an animation control interface that is displayed in an augmented reality (“AR”) environment and/or a virtual reality (“VR”) environment.

15. The method according to claim 13, wherein:
a first object of the plurality of objects defines a first convex hull,
other objects of the plurality of objects each define a corresponding convex hull, and
the processor identifies an unsolvable case when each disassembly path for the first object results in a collision of the first convex hull with at least one other convex hull of the other objects.

16. The method according to claim 1, wherein:
the disassembly algorithm is a physics-based assembly-by-disassembly algorithm, and
the disassembly algorithm assumes (i) the objects of the plurality of objects are rigid bodies having fixed geometries, (ii) there are no multi-object dependencies, (iii) the virtual model is an accurate representation of the assembly, and (iv) effects from external forces, including gravity and friction, are disregarded.

17. The method according to claim 1, further comprising:
repeating the authoring for each object of the plurality of objects.

18. The method according to claim 1, further comprising:
generating an interactive liaison diagram that visualizes dependencies between the objects of the plurality of objects, and
displaying the interactive liaison diagram in an augmented reality (“AR”) environment and/or a virtual reality (“VR”) environment.

19. The method according to claim 1, wherein the animated instructional content is for an augmented reality (“AR”) environment and/or a virtual reality (“VR”) environment to assist a user in assembling the assembly.

20. The method according to claim 19, wherein in response to seeing the animation in the AR environment or the VR environment, the user assembles at least one physical agent object corresponding to the at least one agent object on at least one physical target object corresponding to the at least one target object to assemble the assembly.
